(19) United States
(12) Patent Application Publication
(10) Pub. No.: US 2004/0023082 A1
(43) Pub. Date: Feb. 5, 2004

(54) Fuel cell having activation mechanism and method for forming same

(76) Inventors: Ronald James Kelly, Coral Springs, FL (US); Steven Duane Pratt, Ft. Lauderdale, FL (US); Sivakumar Muthurswamy, Plantation, FL (US); Robert W. Pennisi, Boca Raton, FL (US); Mark S. Bresin, Plantation, FL (US)

Correspondence Address: Andrew S. Fuller, Motorola, Inc., Law Department, 8000 West Sunrise Boulevard, Fort Lauderdale, FL, 33322, US

(21) Appl. No.: 10/209,230

(22) Filed: Jul. 31, 2002

(51) Int. Cl. H01M 8/00; H01M 8/10; H01M 2/08

(52) U.S. Cl. 429/12; 429/19; 429/30; 429/35

(57) ABSTRACT

A fuel cell device (100) has a configuration for easy activation to quickly achieve steady-state operation performance. The fuel cell device (100) has a membrane electrode assembly (MEA) (120) and fuel (115) housed in separate sealed compartments (112, 114). The MEA (120) is pre-hydrated to have a predetermined water content selected for proper steady-state operation of the fuel cell. Prior to activation, the MEA (120) is sealed from air and sealed from the fuel (115). An integral fuel cell activator mechanism (105, 106, 140) is provided to unseal the MEA compartment (112) and expose the MEA (120) to air, and to initiate a flow of fuel (115) from the fuel compartment (114) to the MEA (120).

### TECHNICAL FIELD

This invention relates in general to fuel cells, and more particularly, to fuel cells constructed to facilitate activation.

### BACKGROUND

Fuel cells are electrochemical cells in which a free energy change resulting from a fuel oxidation reaction is converted into electrical energy. A typical fuel cell consists of a fuel electrode (anode) and an oxidant electrode (cathode), separated by an ion-conducting electrolyte. The electrodes are ordinarily arranged into a membrane electrode assembly (MEA). An external circuit conductor electrically connects the electrodes to a load, such as an electronic circuit. In the circuit conductor, electric current is transported by the flow of electrons, whereas in the electrolyte it is transported by the flow of ions, such as the hydrogen ion (H+) in acid electrolytes, or the hydroxyl ion (OH—) in alkaline electrolytes. In theory, any substance capable of chemical oxidation that can be supplied continuously (as a gas or fluid) can be oxidized as the fuel at the anode of the fuel cell. Similarly, the oxidant can be any material that can be reduced at a sufficient rate. Gaseous hydrogen has become the fuel of choice for many applications, because of its high reactivity in the presence of suitable catalysts and because of its high energy density. At the fuel cell cathode, the most common oxidant is gaseous oxygen, which is readily and economically available from the air for fuel cells used in terrestrial applications.

When gaseous hydrogen and oxygen are used as fuel and oxidant, the electrodes are porous to permit the gas-electrolyte junction to be as great as possible. The electrodes must be electronic conductors, and possess the appropriate reactivity to give significant reaction rates. At the anode, incoming hydrogen gas ionizes to produce hydrogen ions and electrons. Since the electrolyte is a non-electronic conductor, the electrons flow away from the anode via the metallic external circuit. At the cathode, oxygen gas reacts with hydrogen ion migrating through the electrolyte and the incoming electrons from the external circuit to produce water as a byproduct. The byproduct water is typically extracted through evaporation. The overall reaction that takes place in the fuel cell is a sum of the anode and cathode reactions, with part of the free energy of reaction released directly as electrical energy. As long as hydrogen and oxygen are fed to a properly functioning fuel cell, the flow of electric current will be sustained by electronic flow in the external circuit and ionic flow in the electrolyte.

Fuel cells hold much promise in extending the operating time of portable devices, and have been considered as potential replacement power sources for disposable primary cells. However, several issues exist in providing for consumer-friendly implementations. For instance, a fuel cell must be activated, i.e., the fuel cell must be properly hydrated in order to achieve optimum performance. The hydration process generally involves a time consuming processing of cycling the fuel cell on and off in a prescribed fashion to cause water to diffuse into the fuel cell membrane. Once the fuel cell has been activated, it has a limited shelf life because the membrane will eventually dry out if not in operation for an extended period of time. Another problem is that fuel cell configurations commonly require numerous components such as gas regulators, valves, and other ancillary devices for operation. The use of a large number of components in fuel cell construction typically results in an expensive and complex solution not well suited for disposable use.

The promise of fuel cells for wide scale portable device applications has yet to be realized. Particularly, design configurations suitable for simple activation and operation are not adequately available. Therefore, a new user-friendly approach is needed for a fuel cell that can be easily activated to optimal operating conditions.

### BRIEF DESCRIPTION OF THE DRAWINGS

FIG. 1 is a cross-sectional view of a fuel cell device prior to activation, in accordance with the present invention.

FIG. 2 is a planar view of the fuel cell device, in accordance with the present invention.

FIG. 3 is a cross-sectional view of the fuel cell device after activation, in accordance with the present invention.

### DETAILED DESCRIPTION OF THE PREFERRED EMBODIMENT

The present invention provides for a fuel cell device configuration having a simple construction and user-friendly activation mechanism. The fuel cell device includes a housing having a reservoir portion containing fuel, and a sealed compartment portion containing a hydrated membrane electrode assembly (MEA). The MEA is hydrated to have a predetermined water content selected for proper steady-state operation of the fuel cell. The MEA has a cathode side sealed from air, and an anode side sealed from the fuel. An integral fuel cell activator has one or more mechanisms to unseal the sealed compartment, thereby exposing the cathode side of the MEA to air, and exposing the anode side of the MEA to a flow of fuel from the fuel reservoir. In this manner, the fuel cell can be easily activated to quickly achieve peak operating performance.

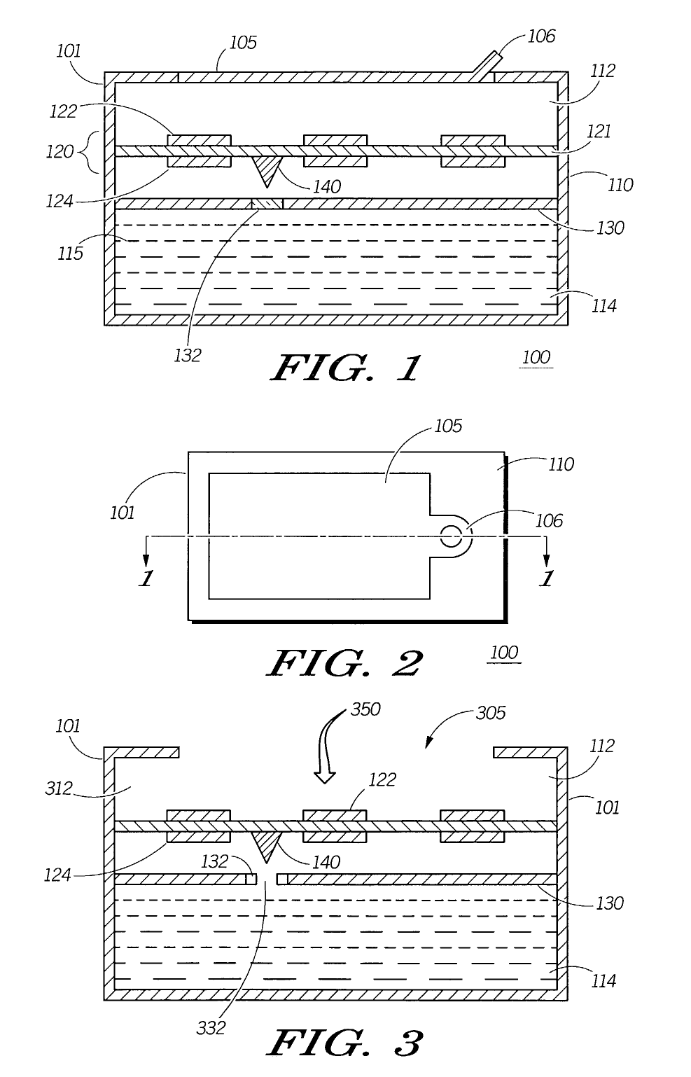

FIG. 1 shows a cross-sectional view of a fuel cell device 100, in accordance with the present invention. FIG. 2 shows a top plan view of the fuel cell device 100. Referring to FIG. 1 and FIG. 2, the fuel cell device of the preferred embodiment includes a housing structure 101 that houses a membrane electrode assembly (MEA) 120 and fuel 115. The MEA 120 is preferably formed from a flexible polymer electrolyte membrane (PEM) 121 of planar construction. The MEA 120 has an array of cathodes 122 disposed on one side of the PEM 121, and an array of anodes 124 disposed on an opposite side of the PEM 121. The PEM 121 is preferably formed from perfluorinated sulfonic acids derived from fluorinated ethylenes, and polybenzimidazole. The construction of the MEA 120 is similar to that described in U.S. Pat. No. 6,127,058, issued to Pratt et al., on Oct. 3, 2000, which is hereby incorporated in its entirety by reference.

According to the invention, the MEA 120 is pre-hydrated, upon manufacture, with an amount of water selected to provide optimum startup hydration for proper operation of the fuel cell device. The level of hydration is dependent upon the construction and particular materials used for forming the MEA and is usually at least twenty percent (20%) by percentage weight volume. For example, membranes formed from solid electrolyte materials commercially available as NAFION™ 117 or NAFION™ 112, are hydrated to have approximately thirty-four percent (34%) water content, while membranes formed with materials commercially available as GORESELECT™ 1100 or GORE-SELECT™ 900 are hydrated to have approximately thirty-two percent (32%) and forty-three percent (43%) water content, respectively. The membranes can be hydrated by boiling in de-ionized water or by other suitable means.

The housing structure 101 of the preferred embodiment has a hermetically sealed compartment 112 for housing the MEA 120, and a fuel reservoir compartment 114 for housing the fuel 115. A barrier 130 separates both compartments 112, 114 and functions as a seal to prevent fuel 115 from entering the MEA compartment 112 and engaging the MEA 120. The barrier seal 130 is preferably a membrane impermeable to gas. The MEA compartment 112 is secured or sealed at one end at least in part by housing member 105, and at another end at least in part by the barrier seal 130. The hydrated MEA 120 is positioned within the MEA compartment 112 such that the side with the cathodes 122 is oriented toward or faces the housing member 105, and such that the side with the anodes 124 is oriented or faces toward the barrier member 130.

The fuel reservoir 114 is preferably integrally formed with the housing 101 from stainless steel. The barrier member 130 forms at least a portion of one wall of the fuel reservoir. The barrier member 130 has a thinned or weakened section 132 that forms a rupturable portion of the barrier. The weakened section 132 can also be formed from metalized Mylar, thin glass, or aluminum metal, which could be easily broken when twisted or punctured. The fuel 115 contained in the fuel reservoir 114 is preferably chemically stored in a chemical hydride or metal hydride or methanol released by reaction, or is stored as gaseous hydrogen in carbon nanotubes, or pressurized containers. In the preferred embodiment, a metal hydride is used for fuel. Most common metal hydrides of the form AB or AB₅ can be formulated into materials that have a low hydrogen vapor pressure. An example would be an alloy of FeTi such as FeO ₈Ni_{0.2}Ti, which is below or near atmospheric pressure at room temperature. Another example would be the AB₅ system LaNi₅. Low-pressure alloys would be LaNi_{4.7}Al_{0.3}, which is at nearly ½ an atmosphere at room temperature. Varying the aluminum content varies the room temperature pressure, which can be customized for the application.

In the preferred embodiment, the fuel cell device 100 incorporates a fuel cell activator mechanism including a mechanism for exposing the MEA 120 to an oxidant supply (air), and a mechanism for initiating the flow of fuel to the MEA 120. To provide a mechanism for exposing the MEA 120 to air, the sealing member 105 is removable, and as such, has a tab 106 that function as a grasping member for moving, and removing the sealing member 105, and unsealing the compartment 112. When the sealing member is removed, the cathode side of the MEA 120 is exposed to air. The removable sealing member 105, which acts as an oxygen and moisture barrier, is easily removed by a user, and could be constructed in a variety of embodiments. The removable sealing member in the preferred embodiment is a pull tab, similar in fashion to that used in canned soda or canned fish applications, and is formed from plastic, metalized plastic, metal, or the like. In an alternative embodiment (not shown), the sealing of the fuel cell is effected by enclosing the entire fuel cell in an airtight plastic bag or other enclosure that provides an oxide/metal barrier. This enclosure is removable or rupturable to expose the MEA to air.

The mechanism for initiating the flow of fuel to the MEA 120 includes a barrier rupture member 140 for engaging the barrier member 130 to unseal the fuel reservoir, thereby creating a flow of fuel from the fuel reservoir to the anode side of the MEA within the sealed compartment. The barrier rupture mechanism of the preferred embodiment is a pin or other projecting member disposed on the MEA, which serves to puncture the weakened portion 132 of the barrier member 130, thereby creating a small hole for the passage of hydrogen. Other barrier rupture mechanisms, whether chemical or mechanical, can be employed for initiating the flow of fuel.

The fuel cell device so constructed has an extended shelf life, as the various seals 105, 130 maintain all chemical components separate from each other until activation is required. The MEA 120 is also appropriately hydrated for optimum fuel cell operation. Just prior to use, the fuel cell device is activated by pulling on the tab 106 to remove the seal 105, thereby exposing the cathode of the MEA to air. Additionally, the MEA 120 is depressed such that the pin 140 or other barrier rupture mechanism punctures and breaks the seal causing the fuel 115 to flow from the fuel reservoir 114 to the anode side of the MEA 120. FIG. 3 shows the fuel cell device after activation. The removal of the seal 105 creates an opening 305 and an unsealed compartment 312 thereby exposing the cathodes 122 of the MEA 120 to air 350. Additionally, an orifice 332 is formed in the weakened portion 132 of the barrier seal that creates a conduit for fuel to the anodes. The fuel cell device is then ready to be placed in operation.

A fuel cell device formed according to the present provides significant advantages over the prior art. The packaging provides for quick and easy activation for optimum performance. With these advancements, fuel cells are closer to function as suitable replacement for commonly used primary cells in consumer-friendly applications.

While the preferred embodiments of the invention have been illustrated and described, it will be clear that the invention is not so limited. For example, the present invention contemplates that the subscriber unit may bypass the use of a brokering agent and use information obtained from the advertising source to select and configure the unit. Numerous other modifications, changes, variations, substitutions and equivalents will occur to those skilled in the art without departing from the spirit and scope of the present invention as defined by the appended claims.

What is claimed is:

1. A fuel cell device, comprising:
a fuel reservoir having fuel contained therein;
a hermetically sealed compartment having a hydrated membrane electrode assembly located therein, and having a movable portion for unsealing the sealed compartment and exposing the membrane electrode assembly to air;
a barrier that separates the fuel reservoir from the sealed compartment; and
a barrier rupture mechanism for engaging the barrier to create an orifice therein that allows a flow of fuel from the fuel reservoir to the membrane electrode assembly within the sealed compartment.

2. The fuel cell device of claim 1, further comprising a pull tab for removing a portion of the sealed compartment.

3. The fuel cell device of claim 2, wherein the barrier comprises a non-gas permeable substrate.

4. The fuel cell device of claim 3, wherein the fuel comprises hydrogen releasable in gaseous form.

5. The fuel cell device of claim 1, wherein the membrane electrode assembly has an amount of water selected to provide optimum startup hydration for proper operation of the fuel cell device.

6. The fuel cell device of claim 1, wherein the hydrated membrane electrode assembly has a membrane structure having a water content of at least twenty percent by weight.

7. A fuel cell device, comprising:
a housing containing fuel;
a membrane electrode assembly (MEA) contained within a sealed portion of the housing, the MEA having a predetermined water content selected for proper fuel cell operation, the MEA having a cathode side sealed from air by a first seal, and a anode side sealed from the fuel by a second seal; and
a fuel cell activator comprising a mechanism for breaking the first seal and exposing the MEA to air, and a mechanism for breaking the second seal to allow a flow of fuel to the MEA.

8. The fuel cell device of claim 7, wherein the fuel cell activator comprises a pull-tab for removing a portion of the first seal.

9. The fuel cell device of claim 7, wherein the fuel cell activator comprises a puncture device for puncturing the second seal.

10. The fuel cell device of claim 9, wherein the puncture device comprises a pin.

11. The fuel cell device of claim 7, wherein the MEA has a water content of at least twenty percent.

12. The fuel cell device of claim 7, wherein the fuel comprises hydrogen in a form selected from the group of metal hydrides, carbon nanotubes, hydrogen in gaseous form, and methanol released by reaction.

13. A method for forming a fuel cell, comprising the steps of:
providing a housing having first and second compartments;
hydrating a membrane electrode assembly to have a water content suitable for steady-state operation in a fuel cell arrangement;
introducing fuel in the first compartment; and
hermetically sealing the hydrated membrane electrode assembly within the second compartment;

14. The method of claim 13, wherein the step of hermetically sealing comprises the step of sealing the hydrated membrane electrode assembly with a sealing structure that provides a built-in a mechanism for unsealing the hydrated membrane electrode assembly to expose the hydrated membrane electrode assembly to air, and to allow a flow of fuel to the hydrated membrane electrode assembly.

15. The method of claim 13, wherein the step of hydrating comprises the step of hydrating the membrane electrode assembly to have at least twenty percent water content.
